(19) United States
(12) Patent Application Publication
(10) Pub. No.: US 2026/0049233 A1
(43) Pub. Date: Feb. 19, 2026

(54) Flexible Metal Polymer Composite

(71) Applicant: Tundra Composites LLC, White Bear Lake, MN (US)

(72) Inventors: Adam Bartel, St. Paul, MN (US); Scott Bohnen, Stillwater, MN (US); John Kroll, Blaine, MN (US)

(73) Assignee: Tundra Composites, LLC, White Bear Lake, MN (US)

(21) Appl. No.: 19/298,710

(22) Filed: Aug. 13, 2025

Related U.S. Application Data
(60) Provisional application No. 63/683,466, filed on Aug. 15, 2024.

(51) Int. Cl. C09J 7/24; C08K 3/08

(52) U.S. Cl. CPC C09J 7/241; C08K 3/08; C08K 2003/0856; C09J 2301/302; C09J 2301/312

(57) ABSTRACT

A material comprising a metal particulate having an interfacial modifier coating and a strain hardening thermoplastic polyolefin elastomer. The composite can be extruded into a variety of cross-sectional shapes and can be formed into a flexible adhesive wheel weight that can be used to rotationally balance vehicle wheels.

### FIELD

The claimed composite is a thermoplastic material comprising a metal particulate having an interfacial modifier coating dispersed in a thermoplastic elastomer. The composite can be extruded into a variety of cross-sectional shapes and can be formed into a flexible wheel weight that can be used to rotationally balance vehicle wheels.

### BACKGROUND

Vehicle wheel weights are characterized by having sufficient density such that in the rotational balancing process, the wheel weight can be added to the appropriate location on a wheel rim to ensure that the wheel and tire is rotationally balanced, particularly at high highway RPM. After some use, wheels are often rebalanced, with new weights, at such times as new tires are installed or the wheel is repaired. In the absence of adequate balancing, the safety and comfort of the vehicle in operation would be seriously affected. Wheel weights currently are in use around the world and include conventional lead weights with an integral clip, adherent metal e.g., zinc or iron weights, and composite flexible materials that can be adhesively applied to a rim. Many available weights such as lead weights have obvious environmental problems, metallic weights are inflexible, can only approximate the correct weight and often do not conform to the wheel geometry, leading to a failure.

A substantial need exists to obtain a flexible, adhesive wheel weight composite that avoids any environmental impact. The weight can be used at the precise amount to balance. The weight must obtain sufficient flexibility such that the wheel weight can adhere to the rim with substantial adhesive (peel) strength. With flexibility and substantial adhesive bonding properties, the wheel weight can adhere to the correct location on the rim surface and establish and maintain rotational balance of a vehicle wheel during the lifetime of the tire and wheel. The adhesive nature enhances assembly and repair.

### BRIEF DESCRIPTION

We have found a composite that is useful in a flexible wheel weight. The composite uses a metallic particulate with a coating of an interfacial modifier combined with a strain hardening thermoplastic polyolefin elastomer. The particulate/polymer composite obtains high density, high particle packing fraction and useful tensile properties.

The polymer used is a strain hardening thermoplastic elastomer. Without this strain hardening character, the composite will not be easily compounded and extruded into a shape and fully functional in use. The mechanical behavior of a thermoplastic elastomer depends on the composition, strain rate, molecular weight, and temperature. Brittle materials break at the strain maximum and at low strain, whereas ductile materials undergo yielding followed by a drop in stress and break at noticeable lower stress but much higher strain. At low strain, the deformation of most solid plastics is elastic. In elastomer, the applied strain is generally proportional to the observed stress, and after removal of the load the material returns to its original shape and size. The maximum up to which the stress and strain remain proportional is called the proportional limit. Strain beyond this limit results in a yield point. At the yield point, the curve leaves the original proportional region. The polymeric material continues to yield and later undergoes strong irreversible plastic deformation followed by necking and fracture, in some cases depending on strain rate and temperature. The term “strain hardening” means the increase in stress that accompanies increase in strain in plastic deformation beyond the strength at yield point. See FIGS. 7-8. Such strain hardening depends on the network density of the composite (minimal Vander Waals bonding, physical entanglements, and chemical cross-links, if any). With increasing temperature, the strain hardening effect decreases. In the claimed material, the elastomer polymer in the composite must stain harden at the use temperature of the weight in its use on the wheel.

The strain hardening thermoplastic polyolefin elastomer is formed into a composite with a modified metal particulate. The unique interaction between the interfacial modifier modification and the particulate promotes a high density but flexible wheel weight with a high packing concentration of metal in the composite. The wheel weight as made typically comprises a linear extrusion having a unique cross-sectional profile that can be easily adapted to and adhered to the differing geometries of the variety of manufacturers vehicle wheels/rims. Many rim geometries are known with different requirements for balancing.

To ensure that the wheel weight can provide adequate balancing to a rotating wheel, the selected profile has a surface of the profile coated with an adhesive. Typically, a pressure-sensitive adhesive (PSA) is used. A PSA bonds by the application of light pressure to the adhesive wheel surface interface. The bond forms because the adhesive can flow and wet to the wheel substrate (adherend). PSAs are designed for either permanent or removable applications. Useful pressure-sensitive adhesives are manufactured in a 100% solid form. PSAs are made and applied using thermoplastic processing. A typical PSA comprises a thermoplastic polymer and a tackifier. Optional materials include plasticizer, stabilizer, filler and

The adhesive must maintain the wheel weight in a precise location on the wheel rim for an extended period (typically the tire lifetime). This ensures that the wheel is balanced during any aspect of operation of the vehicle. In use, the composite material can be easily extracted and provided to a manufacturer in large capacity reels of materials having a useful profile. In use, a small proportion of the material in reel form can be selected to provide exactly the amount of weight required for appropriate balancing. To be successfully stored and used, the adhesive must be covered by a release liner to ensure that the adhesive is not contaminated during manufacture, use, storage, or application and that the adhesive does not cause the wheel weight to adhere to itself, thus ruining stored material. For this purpose, a release liner is typically applied to the surface of the adhesive after it is coated onto the wheel weight profile surface. For ease of use, it is typical to apply a release liner with an edge of the release liner exposed to the user, such that it can be easily grasped and then removed from the weight prior to application.

The term “vehicle wheel” means a combination of a metal, often steel or aluminum, wheel, and a rubber tire. The wheel is typically metallic and often has a structure such that the tire can be mounted, and the wheel weight can be adhered permanently for balancing purposes. Tire takes its conventional meaning in motorized transport vehicles.

The term “particulate” refers to a collection of finely divided particles. The particulate has a range of sizes and morphologies. The maximum particle size is less than 500 microns and is often between 10 and 250 microns. The particulate, coated with interfacial modifier, is dispersed into a thermoplastic polymer.

The term “wheel weight” as claimed in this application relates to an extruded composite material with adhesive having substantial flexibility that can be adapted to conform to the geometry of a vehicle wheel.

The term “extrudate” typically refers to a product of a thermoplastic extrusion process. In an extrusion process, a composite is typically heated to an appropriate temperature and passed through an extruder using the force applied from a rotating screw or auger. The flowable extrudate is then passed through a die that imparts a specific shape to the extrudate.

The term “release liner” refers to a thin film material that can protect an adhesive film on the wheel weight. The release liner can be easily removed from the wheel weight without damaging the adhesive layer such that the adhesive layer can form an adequate bond to the wheel weight on the rim.

The term “strain hardening thermoplastic polyolefin elastomer” relates to a polymer material with substantial viscoelasticity. The polymer has both viscosity characteristics and elasticity characteristics as known. Elastomers typically have a substantial property such that as it is placed under stress it will yield for a substantial amount of increase in its length under stress before it fails. For the claimed materials, the term elastomer typically refers to an amorphous polymer maintained above a glass transition temperature so that the polymer after extension can return to its initial geometry. The elasticity of the material arises within the long chains of the chains of the polymer that are randomly oriented in space. As the polymer is placed under stress, the polymer obtains more of a linear orientation of the polymer change but does not exceed its fracture strain. After release of the stress, the polymer substantially returns to its initial state from its extended form. Preferred elastomers are free of fluorine containing monomer units and constitute strain hardening thermoplastic polyolefin elastomer (POE) materials.

The term “rectangular weight” includes a wheel weight that has at least three planar sides and a fourth side that has a minor departure form a planar surface.

The term “block polymer” means a polymer that has regions in the polymer chain consisting of only one monomer. The balance of the polymer can be random placement of monomers or other blocks and monomers. Polymers that are not “block” polymers have randomly placed monomers along the polymer chain.

The term “close association” generally refers to the packing of particles or particulate within the polymer matrix. The interfacial modifier coating provides a homogeneous surface on the particle even if the particles are dissimilar. Said surface, because of its inert character, permits high volume or weight fraction packing in the polymer matrix without a particle to particle or a particle to polymer reaction to provide the new composite material. This new composite material has the rheological properties of the underlying polymer that is seen in the composite's melt flow during extrusion or injection molding or in other viscoelastic properties such as, for example, tensile elongation.

### BRIEF DESCRIPTION OF THE FIGURES

FIG. 1 to 3 are views of the generally rectangular weight ready for installation. FIG. 1 is a top plan view of the wheel weight release liner with the extruded ferrous metal elastomer composite (not shown and underneath).

FIG. 2 is an end view of a cross section at 2-2 of the article of FIG. 1.

FIG. 3 is a side view of the article of FIG. 1.

FIGS. 4-6 show a variation on the rectangular weight. This weigh has three planar sides and on side with a curved aspect adapted to a curved surface on a wheel rim.

FIGS. 7 and 8 graphically represent the nature of a strain hardening elastomer polymer. In summary, an elastomer that strain hardens, after applying a force, upon reaching a yield point the polymer stress increases before fracture point. A yield point is seen in the stress/strain curve and is reached when the internal association of polymer molecules is disrupted (pulled apart) by force. A fracture is when the test article itself mechanically fails.

### DETAILED DISCUSSION

Novel composites are made by combining an interfacial modified metal particulate and a Strain hardening thermoplastic polyolefin elastomer having a set of specific properties. The metal particulate comprises a thin coating of an interfacial modifier that enhances the physical properties and processing efficiency. The combination of strain hardening thermoplastic polyolefin elastomer and the modified metal particulate obtains a flexible, adhesive wheel weight composite that avoids any environmental impact and provides a precise and accurate balance weight when subsequently cut to a precise and accurate length.

### Thermoplastic Strain Hardening Polyolefin Elastomer

Strain hardening thermoplastic polyolefin elastomer (POE), are a unique class of copolymers that consist of materials with both thermoplastic and elastomeric properties. To qualify as a thermoplastic polyolefin elastomer, a material must have these three essential characteristics: (1) the ability to be stretched to moderate elongations (about 400 to 800% at break) and return to near original shape: (2) melt processed at elevated temperature; and minimal creep character at use temperature.

Strain hardening thermoplastic polyolefin elastomers are relatively easy to use in manufacturing, for example, by extrusion or injection molding. These unique elastomers show advantages typical of both rubber/plastic materials. The benefit of using thermoplastic polyolefin elastomers is the ability to stretch to moderate elongations and return to its near original shape creating a longer life and better physical range than other materials. The principal difference between thermoset elastomers and thermoplastic elastomers is the type of cross-linking bond in their structures. In fact, pseudo-crosslinking or actual chemical crosslinking is a structural factor which imparts elastic properties. Polyolefin elastomers (POE) include Ethylene/1-octene copolymers, ethylene propylene olefin block copolymers (OBCs), Ethylene/propylene random copolymers, polyisobutylene (PIB), poly(a-olefins, e.g., ethene, propene, butene, hexene, octene, etc.), other homopolymer or copolymer polyolefins of monomers such as iso butylene, cyclic olefins, elastomers such as ethylene propylene rubber (EPR), ethylene propylene diene monomer (M-class) rubber (EPDM rubber) and others. Typically, the TPO contains a minimum of 10-20 wt. % ethylene and a minimum of 20 wt. % propylene. Higher ethylene content leads to softer, more flexible TPO. Higher propylene content improves stiffness and heat resistance.

Preferred polyolefin elastomer (POE) is a type of thermoplastic elastomer made primarily from ethylene or propylene and α-olefin comonomers (such as butene, hexene, or octene). It combines the flexibility and rubber-like properties of elastomers with the processability of thermoplastics. POE polymers offer excellent elasticity and impact resistance. Thermoplastic behavior: Can be melted and reshaped, unlike traditional vulcanized rubber. Low density: Lightweight, making it ideal for automotive and packaging applications. Good chemical resistance: Stable against many chemicals and environmental conditions. Excellent low-temperature performance: Maintains flexibility even in cold environments.

The overall ethylene content in the entire TPO blend typically ranges from 10-40%, depending on the elongation and stiffness needed. The overall propylene content in the entire TPO blend typically ranges from 60-90%, depending on the tensile strength and stiffness needed. Suitable polymers include Dow Engage 8480, Exxon/Mobile EXCEED 1012, Enable 2005, Vistamaxx 6000 and other similar materials. LyondellBasell TPO products include SEQUEL, Dexflex, and Catalloy TPO resins.

TABLE 1
Typical property values are as follows:

| Property | Typical Range | | Notes |
|---|---|---|---|
| Melt Flow Rate | 1-10 g/10 min | | Indicates ease of processing |
| (MFR) | | | |
| Density | 0.86-0.90 | g/cm³ | Lightweight material |
| Hardness | Shore A 60-67 | | Soft and flexible surface |
| Tensile Strength | 3-8 | MPa | Good mechanical durability |
| at Break | | | (ASTM D638) |
| Elongation at | 400%-800% | | Excellent stretchability (ASTM |
| Break | | | D638) |
| Flexural | 8-14 | MPa | Low stiffness, enhances |
| Modulus | | | flexibility (ASTM D790) |

### Metal Particulate

The useful particulate is a metallic ferrous metal or an alloy thereof. Typical materials include iron, iron alloys, steel, steel alloys, and other similar alloys with at least 50 wt. % iron. Both magnetic and non-magnetic metals can be used. The metal particles generally useful in the claimed materials typically have a particle size that ranges from about 2 to 500, 2 to 400, 2 to 300, 2 to 200, or 2 to 100 microns, 4 to 300, 4 to 200, or 4 to 100 microns, and often 5 to 250, 5 to 150, 5 to 130, 5 to 125, or 5 to 100 microns. Composites can be made with a single particle size, two blended particle sizes, or three or more particle sizes in a blend. In a single particle composite the packing can be about 75 to 85.5 or about 78 to 82%. Blended particles can attain higher packing levels. A combination of a larger and a smaller particle wherein there is about 0.1 to 25 wt. % of the smaller particle and about 99.9 to about 75 wt. % of larger particles can be used where the ratio of the diameter of the larger particles to the ratio of the smaller is about 2:1, 3:1, 4:1, 5:1, 6:1 or 7:1. In some embodiments there may be three or more components of particle sizes with size ratios such as about 50:7:1 or 350:50:7:1. In other embodiments there may be a continuous gradient of wide particle size distributions to provide higher packing densities or packing fractions. These percentages are based on the particulate. In some embodiments, there may be two or three or more components of particle sizes with specific size ratios. In two particulate blends, a first particulate that is greater than 100 microns is combined with a particulate that is less than 10 microns at a ratio of larger to smaller particulate of about 3-1 parts by volume of the larger to 1 part of the smaller. In three particulate blends, a first particulate that is greater than 100 microns is combined with a second particulate that is about 50 to 10 microns and a third particulate that is less than 10 microns at a ratio of first to second to third particulate of greater than about 10 parts by volume of the first to about 1 part of the second to less than about 5 of the third. These ratios will provide optimum self-ordering of particles within the polymer phase leading to tunable particle fractions within the composite material. The self-ordering of the particles is improved with the addition of interfacial modifier as a coating on the surface of the particle.

The packing density or particle fraction of particles in the composite material varies to specifications required for the utility of the final shaped product as formed via injection molding or extrusion. Values for packing density, volume percent, may be greater than 50, 55, 65, 70 75, 80, 85, 90, 95, or 99. The metal particle composition used in particle metallurgy typically includes many particulate size materials. The particles that are acceptable molding or extrusion grade particulate include particle size, particle size distribution, particle morphology, including circularity index and aspect ratio. Further, the flow rate of the particle mass, the green strength of the initial shaped object, the compressibility of the initial shaped object, the removability or ejectability of the shaped object from the mold, and the dimensional stability of the initial shape during processing is also important.

These materials are not used as large metal particles, but are typically used as small metal particles, commonly called metal particulates. Such particulates have a relatively low aspect ratio and are typically less than about 1:3 aspect ratio. An aspect ratio is typically defined as the ratio of the greatest dimension of the particulate divided by the smallest dimension of the particulate. Generally, spherical particulates are commonly used; however, sufficient packing densities can be obtained from relatively uniformly shaped particles in a dense structure. In some embodiments, the particles may be ball milled to provide mostly round particles. In some instances, the ball-milled particle can have some flat spots. Using the interfacial modifier coating enables the part or shaped article to be extruded from the die with less force than a part or article that is not coated with the interfacial modifier.

### Interfacial Modifier

Interfacial modifiers used in the application fall into broad categories including Group IIIA, or Group VIB element compounds, for example, titanate compounds, zirconate compounds, hafnium compounds, samarium compounds, strontium compounds, neodymium compounds, yttrium compounds, phosphonate compounds, aluminate compounds and zinc compounds. Aluminates, boronates, phosphonates, titanates and zirconates that are useful contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen, and sulfur.

In one embodiment, the interfacial modifier that can be used is a type of organo-metallic material such as organo-cobalt, organo-iron, organo-boron, organo-nickel, organo-titanate, organo-aluminate organo-strontium, organo-neodymium, organo-yttrium, organo-zinc, or organo-zirconate. The specific type of organo-titanate, organo-aluminates, organo-boronate, organo-strontium, organo-neodymium, organo-yttrium, organo-zirconates which can be used, and which can be referred to as organo-metallic compounds are distinguished by the presence of at least one hydrolysable group and at least one organic moiety. Mixtures of organo-metallic materials may be used.

Certain of these types of compounds may be defined by the following general formula:

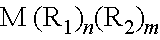

wherein M is a central atom selected from such metals as, for example, Ti, Al, and Zr and other metal centers; R₁ is a hydrolysable group; R₂ is a group consisting of an organic moiety, preferably an organic group that is non-reactive with polymer or other film former; wherein the sum of m+n must equal the coordination number of the central atom and where n is an integer ≥1 and m is an integer ≥1. Particularly R₁ is an alkoxy group having less than 12 carbon atoms. Other useful groups are those alkoxy groups, which have less than 6 carbons, and alkoxy groups having 1-3 C atoms. R₂ is an organic group including between 6-30, preferably 10-24 carbon atoms optionally including one or more hetero atoms selected from the group consisting of N, O, S and P. R₂ is a group consisting of an organic moiety, which is not easily hydrolyzed and is often lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic. R₂ is substantially unreactive, i.e., not providing attachment or bonding to other particles. Titanates provide antioxidant properties and can modify or control cure chemistry. A titanate material can be 2-propanolato, tris iso-octa-decanato-O-titanium IV, an isopropyl tri-isostearoyl titanate. Zirconate provides excellent coating and reduces formation of off color in formulated thermoplastic materials. A useful zirconate material is neopentyl (diallyl) oxy-tri (dioctyl) phosphato-zirconate.

The use of an interfacial modifier results in workable viscosity and improved structural properties in a final use such as a structural member or shaped article. Minimal amounts of the modifier can be used including about 0.005 to 10 wt.-%, about 0.01 to 8 wt.-%, about 0.05 to 6 wt.-%, or about 0.04 to 2 wt. % based on the weight final composite.

The IM coating, with no other components, can be formed as a coating of a dimension equal to at least 3 molecular layers of IM. A substantially complete IM coating has a thickness of less than 1500 Angstroms often less than 200 Angstroms, and commonly 100 to 5000 Angstroms (Å) 50 to 1000 Angstroms (Å) or 10 to 500 Angstroms (Å). Such a coating can obtain minimum adhesion between particulate to particulate and particulate to polymer. Such minimal interaction leads to flexibility.

A composite is more than a simple admixture with properties that can be predicted by the rule of mixtures. A composite is defined as a combination of two or more substances at various percentages, in which each component results in properties of the composite material that are in addition to or superior to those of its constituents. In a simple admixture, the mixed material has little interaction and little property enhancement. In a composite material, at least one of the materials can be chosen to increase stiffness, strength, or density.

The atoms and molecules in the components of the composite can form bonds with other atoms or molecules using several mechanisms. Such bonding can occur between the electron cloud of an atom or molecular surfaces including molecular-molecular interactions, atom-molecular interactions, and atom-atom interactions. Each bonding mechanism involves characteristic forces and dimensions between the atomic centers even in molecular interactions. The important aspect of such bonding force is strength and the variation of bonding strength over distance and directionality. The major forces in such bonding include ionic bonding, covalent bonding, and the van der Waals' (VDW) types of bonding.

Ionic radii and bonding occur in ionic species such as Na⁺Cl⁻, Li⁺F⁻. Such bonding is substantial, often substantially greater than 100 kJ-mol⁻¹ often greater than 250 kJ-mol⁻¹. Further, the interatomic distance for ionic radii tends to be small and can be 1-3 Å. Covalent bonding results from the overlap of electron clouds surrounding atoms forming a direct covalent bond between atomic centers. The covalent bond strengths are substantial, are roughly equivalent to ionic bonding and tend to have somewhat smaller interatomic distances.

The varied types of van der Waals' forces are different than covalent and ionic bonding. These van der Waals' forces tend to be forces between molecules, not between atomic centers. In the composites of the claimed materials strong covalent or ionic bonding is avoided. Reactive coupling agents that bond polymer to ferrous particle are not used. The blended ferrous particle polymer composite as shown in the embodiments is formed with van der Waals bonding as modified and reduced by the IM coating.

Such minimal VDW forces, because of the nature of the fluctuating polarization of the molecule, tend to be low in strength, typically 50 kJ mol−1 or less. Further, the range at which the force becomes attractive is also substantially greater than ionic or covalent bonding and tends to be about 3-10 Å.

In the interfacial modifier (IM) modified van der Waals composite materials, we have found that the unique combination materials result in the creation of a unique van der Waals' bonding. The van der Waals' forces minimize force between molecules/aggregates/crystals and are created by the combination of particle size, polymer, and interfacial modifiers in the composite.

The claimed materials are characterized by a composite having intermolecular forces between ferrous particles less than 30 kJ-mol⁻¹ and a bond dimension of 3-10 Å.

An interfacially modified metal has a substantially complete coating of an interfacial modifier (IM) with a thickness of less than 1500 Angstroms often less than 200 Angstroms, and commonly 10 to 500 Angstroms (Å) or 100 to 1500 Angstroms (Å).

The process and physical property benefits of utilizing the coating becomes evident when packing to a significant proportion of the maximum packing fraction; this value is typically greater than approximately 70, 80, 90, 92 or 95 volume or weight % of the coated particulate phase in the composite.

TABLE 2
Exemplary Composites

| Component | Useful amounts | Useful amounts |
|---|---|---|
| Ferrous particulate | 65-80 | 70-74 |
| (vol. %) | | |
| Ferrous particulate | >90 | >94 |
| (wt. %) | | |
| Interfacial modifier coating | 0.1 to 0.5 | 0.2 to 0.4 |
| (wt. %) | | |
| Strain hardening | 65-80 | 26-30 |
| thermoplastic polyolefin | | |
| elastomer (vol. %) | | |
| Strain hardening | <10 | <6 |
| thermoplastic polyolefin | | |
| elastomer (wt. %) | | |

### Release Liner and Adhesive

A release liner is made of a polymer film or sheet used to prevent the adhesive surface of the weight from contamination from the use environment or from prematurely adhering before it can be applied in wheel balancing. The liner film can be coated with a release agent, which provides or enhances ease of removal without damage to the adhesive layer. Release liners are available in different colors, with or without printing under the low surface energy coating or on the backside of the liner.

The adhesive used in balancing weight material comprises a PSA a pressure sensitive hot melt adhesive. The hot melt adhesive uses a thermoplastic polymer such as an ethylene-vinyl acetate copolymer, acrylate copolymers, olefin polyethylene, polypropylene, polybutene, and its copolymers, thermoplastic urethanes, Styrene block polymers, polycarbonates, silicones, etc. Preferred are pressure sensitive adhesives that are typically formulated by combining a polymer with a tackifying agent and other components such as plasticizers, dyes, stabilizers, etc.

In use, the wheel weight is obtained from an inventory such as length of the material. The inventory, such as a roll inventory, of the extrudate and release liner. The material can be stored on rolls that can contain sufficient inventory to be useful but not so much that the roll is too heavy to handle. In rotational balancing, the balancer machine calculates the necessary weight to rotationally balance the wheel and tire along with the placement of the weight. The exact weight in grams or ounces is then cut form the inventory, the release liner is removed, and the weight article is placed on the rim at the exact location needed. If needed, the operator can confirm the balance.

### DESCRIPTION OF THE FIGURES

The wheel weight article as claimed comprises an extruded polymer composite having a removable release liner adhesively adhered thereto. The composite extrudate comprises a substantially rectangular extrudate with a width substantially greater than its thickness. The release liner is adhered to the weight using an adhesive layer. The release liner is sized and configured such that a small portion of the release liner overlaps and extends past the edge of the wheel weight, while covering the adhesive layer on the surface of the wheel weight below the release liner. The extended portion enables the removal of the liner in the installation process. In use, a portion of a wheel weight extruded composite is selected with a weight appropriate for its balancing purpose. The release liner is then removed from the surface of the wheel weight, and the wheel weight is adhered to the rim of the wheel, using the revealed adhesive material. The adhesive is substantially strong enough such that the wheel weight is semi-permanently attached to the wheel, which is further enhanced using a magnetic ferrous metal in the wheel weight, in combination with a wheel that can bond to magnetic materials.

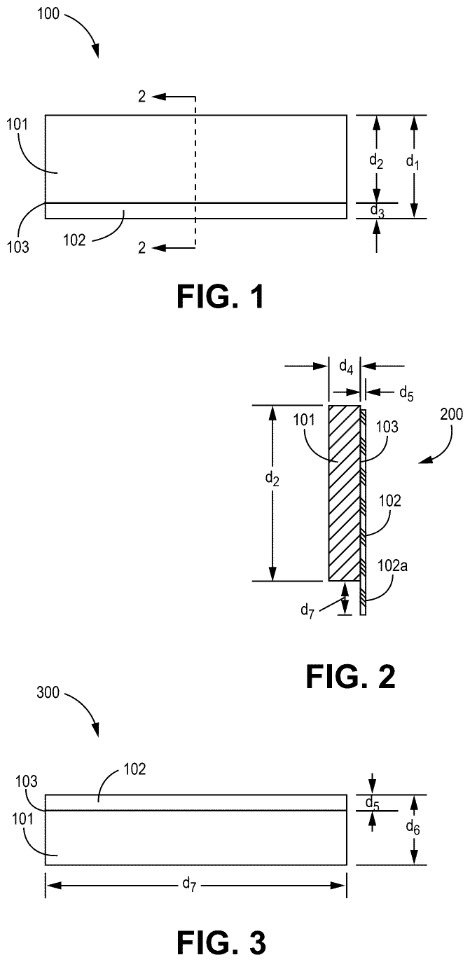

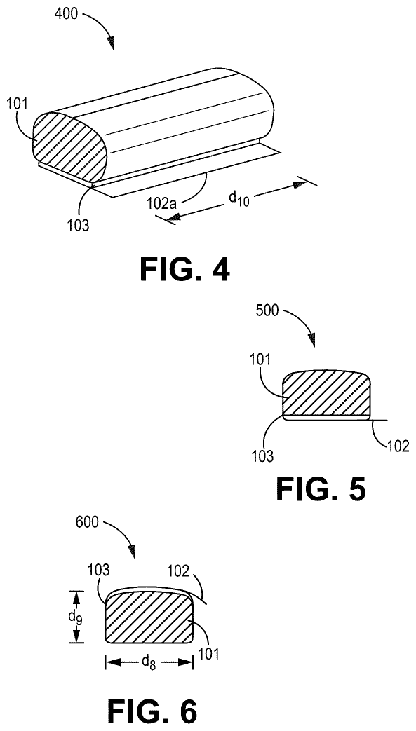

FIGS. 1 to 3 exemplify one useful extruded profile adhesive and release liner combination. Other FIGS. 4 to 6 show that a variety of other profile shapes can be used beneficially in balancing the unique array of vehicle wheel geometries used in both passenger, commercial and other high-speed highway vehicle transport equipment.

FIG. 1 is a top plan view of the wheel weight release liner with the extruded ferrous metal elastomer composite (not shown underneath). FIG. 1 shows us a top view of the wheel weight structure showing the composite with the release liner on the reverse side. In FIG. 1, there is shown a wheel weight 100 comprising the extruded composite 101 (not shown) with the extruded ferrous metal elastomer composite. The wheel weight 100 has extrudate 101, the release layer 102 adhered thereto by the adhesive 103. Wheel weight 100 is shown and defined by dimensions d1, d2, and d3. See table below of typical dimensions.

FIG. 2 is a side view of a cross section at 2-2 of the article of FIG. 1. In FIG. 2, there is shown a wheel weight comprising the extruded composite wheel weight 101, the release liner 102. As can be seen, the thickness of the composite is substantially greater than the thickness of the release liner. The release liner 102 is adhered to the weight with adhesive layer 103. The release liner 102 extends 102a past the weight body 101. In FIG. 2, the extended portion 102a is a portion of the release liner that extends past the top of the extra weight permitting easy removal of the release liner upon application of the weight to the wheel.

FIG. 3 is a side view of the article of FIG. 1. In FIG. 3, there is shown a side view of a portion of the wheel weight that is sized and configured to be directly applied to a wheel. The length of the extruded weight is determined by estimating the weight in grams, or ounces, which provides the exact weight as required to balance the wheel. This length is cut from a supply of the wheel weight roll to roll supply. Like the previous figures, article 300 in FIG. 3 shows the extruded weight 101, the release liner 102, and the adhesive layer 103 positioned there between.

FIGS. 4 to 6 show a variation to a substantially rectangular weight. This weight has three planar sides and on side with a curved aspect adapted to a curved surface on a wheel rim. Wheel weight 400, 500, and 600 is shown and defined by dimensions d8, d9, and d10. See table below of typical dimensions.

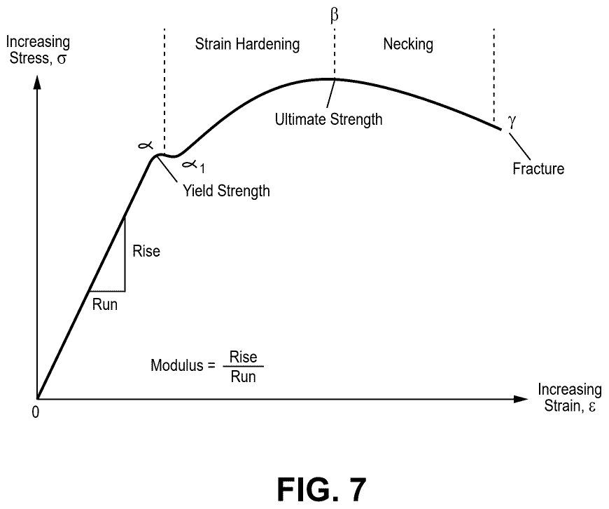

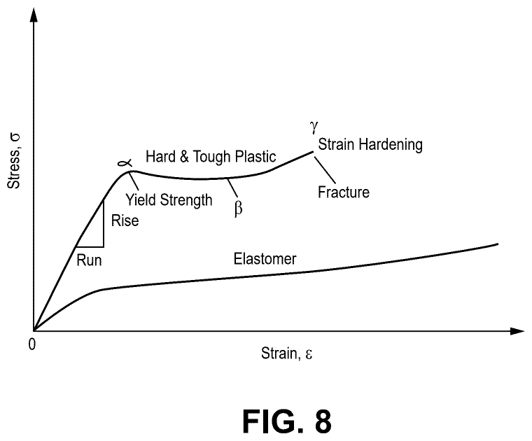

FIGS. 7 and 8 graphically represent the nature of two typical aspects of a strain hardening elastomer polymer. In summary, in an elastomer that strain hardens; after applying a force, the test material yields proportionally to yield point α. A yield point is seen in the stress/strain curve of FIG. 7 and is reached when the internal association of polymer molecules is disrupted (pulled apart) by force. At fracture at γ, the test article itself mechanically fails. In FIG. 7, the yield point is at α, the max strain hardening strength is at β. After the test material necks and fails at γ. A yield point α is seen in the stress/strain curve of FIG. 8 and is reached when the internal association of polymer molecules is disrupted (pulled apart) by force. At fracture at γ, the test article itself mechanically fails. In FIG. 7, the yield point is at α, the max strain hardening strength is between β and fracture at γ. After the test material necks and fails at γ.

TABLE 3
Numerical Indicia in FIGS. 1-3.

| Indicia | Identification | Discussion |
|---|---|---|
| 100 | Wheel weight | Top view -Extrudate with |
| | | rectangular cross section |
| 101 | Composite | Ferrous metal alloy elastomer |
| | | composite |
| 102 | Release liner | Polymeric film release liner |
| | extended portion | |
| 103 | Adhesive layer | Maintains release liner on article |
| | | and protects adhesive until |
| | | installation |
| 200 | Wheel weight | Cross section - Extrudate with |
| | | rectangular cross section |
| 300 | Wheel weight | Extrudate with rectangular cross |
| | | section |

TABLE 4
Dimensions in FIGS. 1-3.

| | | |
|---|---|---|
| d₁ | Width Liner | Width composite plus at least 1 mm |
| d₂ | Width composite | 10 to 23 mm, or 15 to 19 mm |
| | | (Always less than liner width) |
| d₃ | Liner overlap | 1 to 5 mm, or 1 to 2 mm |
| d₄ | Thickness of weight | up to 8 mm, or 4 to 7 mm |
| d₅ | Liner thickness | 0.1 to 0.2 mm, or 0.1 to 0.2 mm |
| d₆ | Thickness of weight | Thickness composite |
| | and liner | plus at least 0.1 to 0.2 mm |
| d₇ | Width | 10 to 23 mm, or 15 to 19 mm |
| | | (Always less than liner width) |
| d₈ | Weight length | 1 to 10 cm, or 2 to 6 mm |
| | (generally depends on | |
| | needed weight to | |
| | balance wheel and | |
| | tire. | |
| d₉ | Height | 5 to 30 mm, or 10 to 25 mm |
| d₁₀ | Width | 5_to 30 mm, or 10 to 25 mm |

### Pellet

The useful object as claimed can be made from a pellet comprising the composite material through extrusion through a shaping die. Pellets are commonly made by extruding the compounded material through a pelleting die and cutting the pellets to size as they emerge from the die. Such a pellet made of the composite can be extruded using a shaping die. In this way, it is used as an intermediate between the compounding of the composite and the manufacturing of the useful object such as the final wheel weight product. A pellet can comprise the composite comprising the components in use concentration of components designed to be directly converted or used in making a useful article. Alternatively, the pellet can comprise a master batch composition with increased amounts, e.g., about 2 to 10 times the amount of ferrous particle such that the pellet can be combined with polymer in proportions that result in producing use concentrations. The pellet is a roughly cylindrical object that can be fed into an extruder input. The pellet is typically 1 to 50, 1 to 60, 1 to 70, 1 to 80, 1 to 90, or 1 to 100 mm in length and 1 to 5, 1 to 10, 1 to 15, or 1 to 20 mm in diameter. A pellet weighs about 10 to 100 mg, 10 to 80 mg, 10 to 70 mg, 10 to 60 mg, 10 to 50 mg, 20 to 50 mg, 20 to 60 mg, 20 to 70 mg, 20 to 80 mg.

### Example 1

50 lbs. stainless-steel particles, particle size 1-400 microns were coated with 0.2 wt. % interfacial modifier with heat applied. 50 lbs. of the coated stainless-steel particles were fed into a co-rotating twin screw compounder with 2.4 lbs. of DOW Engage 8480 ethylene/1-octene (80/20 wt. %) strain hardening thermoplastic polyolefin elastomer pellets. The compounder barrel/screw temperatures were set to 160° C. The composite material was extruded and cut into pellets at the die face of the compounder, and the pellets are then cooled. The composite pellets were fed into a single screw extruder to make the final profile. See FIGS. 1-6. Tensile dogbones were cut from the extruded profile and tested according to ASTM D638 for the properties of maximum tensile stress and maximum tensile elongation.

### Table 5—Examples 2-5

Examples 2-5 are repeated exactly, except using a replacement strain hardening thermoplastic polyolefin elastomer as listed in the following table;

| | | |
|---|---|---|
| Exact 5101 | Exxon Mobile | Ethylene/1-Octene (90/10 wt. %) |
| | | polymer |
| INFUSE 9107 | Dow Chemical | Ethylene/1-Butene (90/10 wt. %) |
| | | Block polymer |
| Vistamaxx 3000 | Exxon Mobile | Propylene (isotactic)/ethylene |
| | | (89/11 wt. %) random polymer |
| Exceed Stiff m | Exxon Mobile | Ethylene/1-hexene (92/8 wt. %) |
| 1327.ma | | Random polymer |

TABLE 6
Typical Properties of the Tensile Dog Bone

| Property | ASTM Method | Value | Units |
|---|---|---|---|
| Tensile Elongation | D638 | 593 | % elongation |
| at break | | | |
| Max. Tensile stress | D638 | 2.29 (333) | MPa (psi) |

The claims may suitably comprise, consist of, or consist essentially of, or be substantially free or free of any of the disclosed or recited elements. The claimed technology that is illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims.

While the above specification shows an enabling disclosure of the composite technology, other embodiments may be made with the claimed materials. Accordingly, the disclosed wheel weight is embodied solely in the claims hereinafter appended.

We claim:

1. A wheel weight comprising a linear composite extrudate, a layer of adhesive and a release liner adhered thereto, wherein:
(i) the linear composite extrudate, free of fluoropolymer, comprises 90 to 97 wt. % of a metal particulate coated with 0.05 to 0.4 wt. % an interfacial modifier, the particulate having a particle size of 1 to 400 microns and 3 to 10 wt. % of a strain hardening thermoplastic polyolefin elastomer, the linear composite extrudate having a rectangular cross section, a width of about 10 to 23 mm and a thickness of less than about 8 millimeters, the particulate having a coating thickness of less than 1000 Å;
(ii)) the adhesive layer providing a 90° peel strength of 3 kg and
(iii) a release liner having a width of about 1 mm greater than the composite and a thickness of 0.1 to 0.2 mm, the release liner width is at least one millimeter greater than that of the linear extrudate;
wherein the composite an elongation at break of about 400% (ASTM D638) and a flex modulus (ASTM D790) greater than about 6 MPa and the linear extrudate has a density of greater than 5 g-cm⁻³ and about 4 to 6 g-cm⁻¹.

2. The wheel weight of claim 1 wherein the strain hardening thermoplastic polyolefin elastomer is an ethylene propene copolymer.

3. The wheel weight of claim 1 wherein the strain hardening thermoplastic polyolefin elastomer is an ethylene 1-butene copolymer.

4. The wheel weight of claim 1 wherein the strain hardening thermoplastic polyolefin elastomer is an ethylene 1-hexene copolymer.

5. The wheel weight of claim 1 wherein the strain hardening thermoplastic polyolefin elastomer is an ethylene 1-octene copolymer.

6. The wheel weight of claim 1 wherein the strain hardening thermoplastic polyolefin elastomer is a block propylene alpha olefin copolymer comprising a major proportion of propylene.

7. The wheel weight of claim 1 wherein the strain hardening thermoplastic polyolefin elastomer is a block propylene ethylene copolymer having a major proportion of propylene.

8. The wheel weight of claim 1 wherein the strain hardening thermoplastic polyolefin elastomer has an elongation at break of greater than 500% (ASTM D638).

9. The wheel weight of claim 1 wherein the interfacial modifier coating thickness is less than 2 nm.

10. The wheel weight of claim 1 wherein the composite exhibits strain hardening with an increase in stress that accompanies increase in strain in plastic deformation beyond the strength at yield point.

11. The wheel weight of claim 1 wherein the rectangular cross section also comprises three planar sides and one side with a curved aspect adaptable to a curved surface on a wheel rim.

12. The wheel weight of claim 1 wherein the composite has the following properties:

| Property | Typical Range | | |
|---|---|---|---|
| Melt Flow Rate (MFR) | 1-10 g/10 min | | |
| Density | 0.86-0.90 | g/cm³ | |
| Tensile Strength at Break | 3-8 | Mpa | (ASTM D638) |
| Elongation at Break | 400%-800% | | (ASTM D638) |
| Flexural Modulus | 8-14 | Mpa | (ASTM D790).. |

13. A wheel weight comprising a linear composite extrudate, a layer of adhesive and a release liner adhered thereto, wherein:
(i) the linear composite extrudate, free of fluoropolymer, comprises 90 to 97 wt. % of a metal particulate coated with 0.05 to 0.4 wt. % an interfacial modifier, the particulate having a particle. size of 1 to 400 microns and 3 to 10 wt. % of a strain hardening thermoplastic ethylene/octene elastomer, the linear composite extrudate having a rectangular cross section, the particulate having a coating thickness of less than 1000 Å;
(ii)) the adhesive layer providing a 90° peel strength of greater than 0.5 kg and
(iii) a release liner having a thickness of 0.1 to 0.2 mm, and the release liner width is at least one millimeter greater than that of the linear extrudate;
wherein the composite an elongation at break of about 400% (ASTM D638) and a flex modulus (ASTM D790) greater than about 6 MPa and the linear extrudate has a density of greater than 5 g-cm⁻³ and about 4 to 6 g-cm⁻¹.

14. The wheel weight of claim 13 wherein the thermoplastic elastomer polymer is an ethylene propylene copolymer.

15. The wheel weight of claim 13 wherein the strain hardening thermoplastic polyolefin elastomer is an ethylene 1-octene copolymer.

16. The wheel weight of claim 13 wherein the strain hardening thermoplastic polyolefin elastomer has an elongation at break of greater than 500% (ASTM D638).

17. The wheel weight of claim 13 wherein the interfacial modifier coating thickness is less than 2 nm.

18. The wheel weight of claim 13 wherein the composite exhibits strain hardening with an increase in stress that accompanies increase in strain in plastic deformation beyond the strength at yield point.

19. The wheel weight of claim 13 wherein the rectangular cross section also comprises three planar sides and one side with a curved aspect adaptable to a curved surface on a wheel rim

20. The wheel weight of claim 13 wherein the composite has the following properties:

| | |
|---|---|
| Property | Typical Range |
| Melt Flow Rate (MFR) | 1-10 g/10 min | | |
|---|---|---|---|
| Density | 0.86-0.90 | g/cm³ | |
| Tensile Strength at Break | 3-8 | MPa | (ASTM D638) |
| Elongation at Break | ≥400% | | (ASTM D638) |
| Flexural Modulus | ≥8 | MPa | (ASTM D790). |
